(19) United States
(12) Patent Application Publication
(10) Pub. No.: US 2019/0009808 A1
(43) Pub. Date: Jan. 10, 2019

(54) APPARATUS, SYSTEM, AND METHOD FOR IMPROVING STAGING, DELIVERY, AND RECEIVING OF SHIPPED PRODUCTS

(71) Applicant: Tom SELIQUINI, Glen Allen, VA (US)

(72) Inventor: Tom SELIQUINI, Glen Allen, VA (US)

(21) Appl. No.: 15/995,106

(22) Filed: May 31, 2018

Related U.S. Application Data
(60) Provisional application No. 62/512,906, filed on May 31, 2017.

(51) Int. Cl. B62B 3/06; B62B 3/10

(52) U.S. Cl. CPC B62B 3/06; B62B 3/10

(57) ABSTRACT

The present invention discloses an apparatus, system and a method providing for a self-contained, adjustable, mobile, mechanical pallet and cart stacking system for use in (a) stacking and staging all types of products and related implements within the seller/vendor's warehouse facilities, (b) stacking and securing the products, and implements within the enclosed delivery truck cargo spaces during the transport to customers of such implements, while increasing/maximizing the utilization of space within the enclosed cargo area of the transport truck by adjusting to the heights of less-than-full pallets of said implements thereby allowing for more implements to be loaded and transported, and finally (c) the self-contained process of off-loading, receiving and staging of the implements at the location of the customers of the implements without the need for additional equipment. The disclosed system, however, allows for adjusting the apparatus to accommodate stacking multiple pallets and/or carts to maximize cubic capacities and reduce square footage requirements.

### PRIORITY CLAIM

Applicant claims priority from U.S. Provisional Application No. 62/512,906, filed May 31, 2017, the contents of which are incorporated herein, in their entirety, by reference.

### BACKGROUND

### Technical Field

The present disclosure relates to material handling systems and more particularly to devices and methods for lifting partial loaded pallets and/or flatbed carts containing implements. The present disclosure also relates to the square foot space needed to store these pallets and carts in warehouses and delivery vehicles such as tractor trailers and the inefficient use of that square footage.

### Background Art

Pallets are known in the art of warehousing, stacking, staging and transporting implements for shipping and/or receiving. A pallet, sometimes inaccurately called a skid (a skid has no bottom deck boards), is a flat transport structure that supports goods in a stable fashion while being lifted by a forklift, pallet jack, front loader, work saver, or other jacking device, or a crane. A pallet is typically 40″ wide and 48″ deep and is the structural foundation of a unit load which allows handling and storage efficiencies. Pallets are generally made from wood and have multiple stringers and deck-boards for security and stability. When transporting these pallets on delivery vehicles, an optimal height would be about 6 feet in order to maximize the available cubic feet inside the delivery vehicle. These pallets often times have excess capacity as the implements they contain do not reach the 6 foot height.

Flatbed carts, sometimes called platform carts are known in the art of warehousing, stacking, staging and transporting implements for shipping and/or receiving. A typical flatbed cart, has a flat surface that supports goods in a stable fashion while being pushed or pulled. The flat surface has 4 wheels secured under it and a handle on one end to facilitate the pushing and pulling as it is positioned in a desired location. A flatbed cart is typically 40 inches wide and 60 inches deep and is the structural foundation of a unit load which allows handling, storage and transporting efficiencies. Flatbed carts are generally made from steel or plastic with various sizes of casters including locking casters.

One problem associated with pallets and flatbed carts is encountered when there is limited square footage space in the area being used to stage and deliver outbound pallets and carts. When these pallets and carts contain small amounts of implements (3 feet high or less), they take up the same amount of square footage as would a full pallet or cart (6 feet high). When there are many small loads like this being staged at the same time, the square footage is not efficiently utilized. Similarly when there are many small loads being delivered, the cubic space utilized is inefficient. Depending on the amount of small load pallets and carts, this can create a navigation issue as workers try to circumnavigate staged pallets and carts. Efficiencies are lost as worker travel times increase. Delivery vehicles may have to make multiple trips to complete the deliveries to these customers thereby increasing transportation costs.

What is needed then is a device that can safely and securely lift and raise these small load pallets and carts in an easy and efficient way so that the square footage underneath of that raised pallet or cart can be used to stage or deliver another small load pallet or cart.

### BRIEF SUMMARY

The present disclosure provides devices and methods for lifting pallets and carts in such a way that when lifted, the device allows for the utilization of the square footprint beneath it.

In some embodiments, the present disclosure provides an apparatus for lifting a small load pallet and/or a flatbed cart to a maximum height of 5 feet so that a second small load pallet or flatbed cart can be placed beneath it from either the front side or back side. The apparatus has forks extending from the base frame that is connected to a cable and pulley system. A winch with a hand crank is then used to raise and lower the forks. The apparatus is designed to safely hold the expected maximum weight of implements or materials. The front and rear casters are designed to roll on concrete or tile floors as is the case in most warehouse environments. The winch, cable, and forks are designed for easy access by the operator and are stationary in a fixed location at the rear of the apparatus. The cable system is preferably embedded or contained within the frame and includes a locking and/or release mechanism to protect the load from inadvertently falling or lowering.

In other embodiments, the present disclosure provides an apparatus that allows for the stacking of small load pallets and carts onto a delivery vehicle such as a tractor trailer. The front casters are designed to easily roll onto the back of a delivery vehicle when using a dock door ramp or dock plate. The secured raised position allows the operator to place a second small load pallet or cart underneath the raised load thereby maximizing the total cubic feet of trailer space. The apparatus would stay in the raised position until the vehicle has reached the destination. At the receiving location, the operator pulls the lower pallet or cart off the trailer first then lowers the forks on the apparatus to a lower position, e.g., about 6 inches off the floor, and pulls it off of the trailer. While inside the receiving location, the operator removes the pallet or cart from the apparatus and prepares to return it to the owner.

The apparatus, system, and method disclosed herein provide for a self-contained, adjustable, mobile, mechanical pallet and cart stacking system for use in (a) stacking and staging all types of products and related implements within the seller/vendor's warehouse facilities, (b) stacking and securing the products, and implements within the enclosed delivery truck cargo spaces during the transport to customers of such implements, while increasing/maximizing the utilization of space within the enclosed cargo area of the transport truck by adjusting to the heights of less-than-full pallets of said implements thereby allowing for more implements to be loaded and transported, and finally (c) the self-contained process of off-loading, receiving and staging of the implements at the location of the customers of the implements without the need for additional equipment.

Many existing systems such as pallets and wheeled carts only allow for a single footprint of product containment within a warehouse staging area and/or within the inside of a truck's trailer resulting in significant non-use of cubic capacity related to the staging, transporting and receiving of these products. As will be appreciated by those in the art, the various components of the proposed StackJack system disclosed herein allows for adjusting the apparatus to accommodate stacking multiple pallets and/or carts to maximize cubic capacities and reduce square footage requirements.

### BRIEF DESCRIPTION OF DRAWINGS

FIG. 1 illustrates an operators' view of all of the main components of an embodiment of the apparatus with the forks in a lowered position.

FIG. 2 illustrates an operators' view of an embodiment of the apparatus in a raised and secured position.

FIG. 3 illustrates a plan view of an embodiment of the apparatus in a raised position with a pallet being stored underneath it.

FIGS. 4A and 4B show an embodiment of a support mechanism that may be used with the basic apparatus.

FIGS. 5A and 5B show another embodiment of a support mechanism that may be used with the basic apparatus.

FIG. 6 shows an embodiment with a single set of lifting forks.

FIG. 7 shows an embodiment with a single set of lifting forks and a support structure for supporting a second pallet.

FIG. 8 shows an embodiment with two sets of lifting forks for lifting two separate pallets.

The Figures provided herewith depict various embodiments of the disclosure for purposes of illustration only and are not drawn to scale and may omit elements for clarity. One skilled in the art will readily recognize from the following discussion that alternative embodiments of the structures and methods illustrated herein may be employed without departing from the principles of the invention described herein.

### DETAILED DESCRIPTION

It is understood that in the drawings, not all reference numbers are included in each drawing for the sake of clarity. In addition, positional terms such as “upper,” “lower,” “raised,” “front,” “back,” “side,” “rear,” “above,” “below,” etc., refer to the apparatus when in a use orientation as shown in the drawings. The skilled artisan will recognize that the relative and absolute positioning of certain elements of embodiments of the apparatus in accordance with the present disclosure can and will assume different orientations when in use.

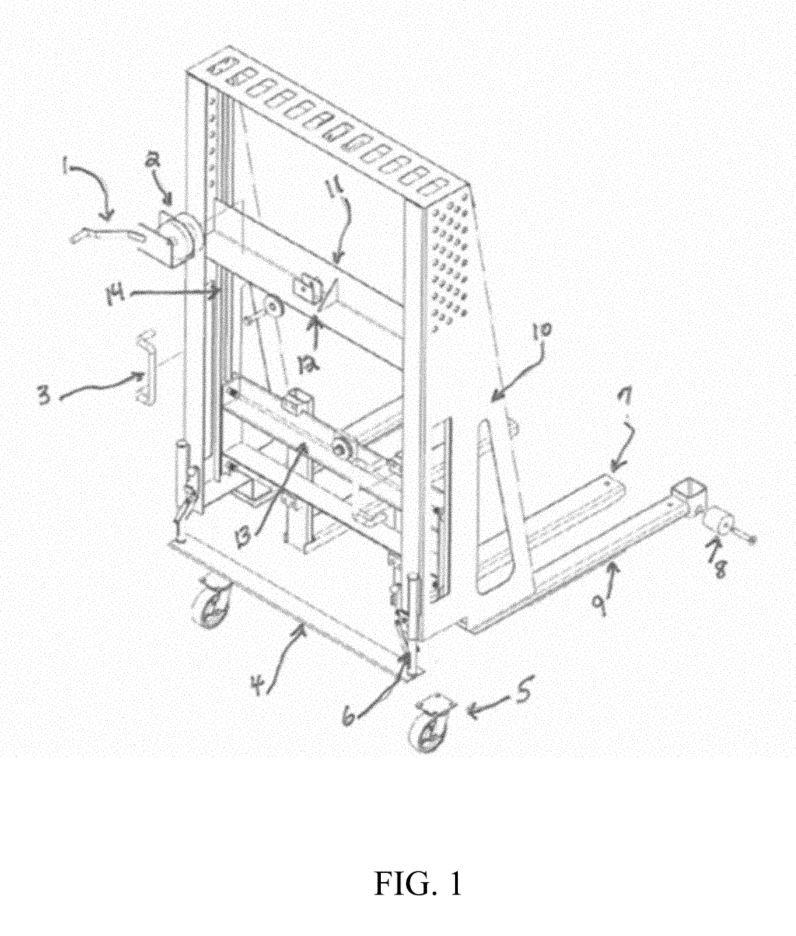

Referring now to the drawings, the present disclosure includes embodiments of an apparatus arranged and configured for lifting a pallet, skid, and/or cart. FIG. 1 illustrates a first embodiment of a lifting apparatus with the lifting forks in a lowered position. A crank handle 1, is turned in a clockwise fashion to raise and counter-clockwise to lower the forks. It is attached to a winch 2, which can be locked into position to prevent inadvertent lowering. A cable 14, which is attached to the winch on one end and the fork housing apparatus 13, and on the other end is embedded into the upper frame 10 and runs around pulleys and/or guides preferably located within the fork housing and upper frame 10. The adjustable forks 7 are attached to the fork housing 13 with grooves and notches and the width between the left and right forks can be adjusted to small, e.g., 1-inch increments.

The winch and pulley housing/mount 11 comprises part of the upper frame and provides added structural support to the overall apparatus. There are handles 3 on both sides of the apparatus which are used in moving it by a pulling or pushing motion from the operator. This motion is supported by front casters 5 (which are mounted on a lower portion of the frame and may provide a locking function) and back casters 8 which are housed inside the lower frame 9. A spring-loaded or otherwise biased cross bar 4 provides support to the overall apparatus and, during operation, may be depressed and locked in a lower position that will allow a pallet or cart to be moved over the cross bar 4 and placed under the load supported by the raised forks. This bar is released from its lowest position when the operator activates the release footswitch 6 or other release mechanism.

In some embodiments, the manual lifting mechanism including the winch, pulley and cable system may be replaced partially or completely with hydraulic, pneumatic, electric, and/or other mechanical mechanisms efficient systems.

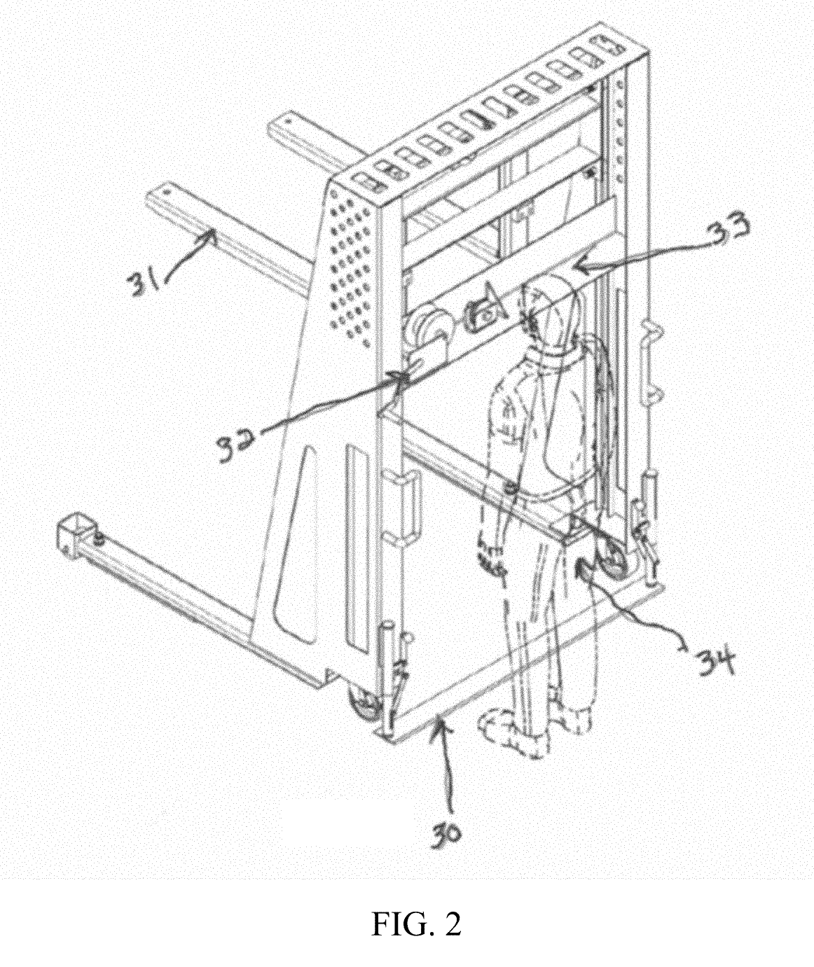

Referring to FIG. 2, the illustration demonstrates the apparatus in a raised position. The cross support bar 30 is in the lowered and locked position. This will permit the operator to position another pallet and/or cart underneath it. The hand crank 32 has been rotated clockwise to lift and lock the fork housing and forks. The forks 31 are shown to be in their highest raised position and parallel with the fixed winch housing 33.

An operator 34 will typically operate the apparatus from a position at the front of the apparatus, a position that provides access to all controls, handles, cranks, locks, and releases, while the load(s) are handled on the opposite side of the apparatus.

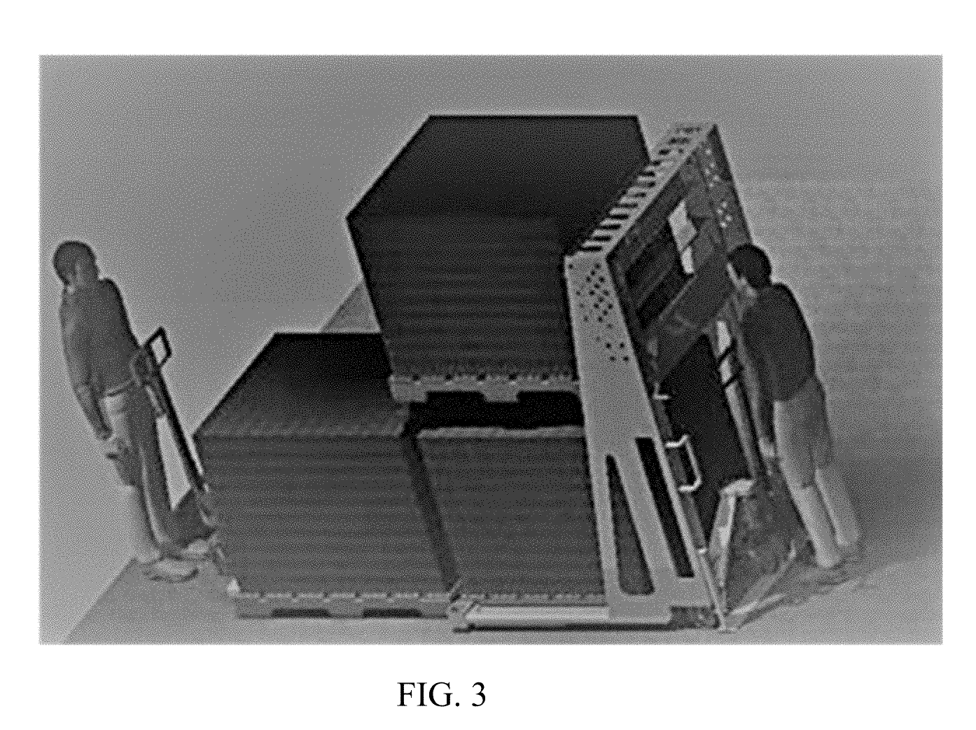

Referring to FIG. 3, the illustration demonstrates the positioning of a pallet of implements underneath the apparatus from the front using a conventional pallet jack.

Some embodiments of the apparatus include a frame comprising an upper frame 10, which supports the lift mechanism in the pallets, and a lower frame 9 provides a lateral extension of the apparatus and supports the wheels/casters/rollers 5, 8 that will allow the apparatus to move across the work floor. Depending on the application, one or more of the wheels/casters/rollers 5, 8 may be fixed, may provide limited horizontal rotation, or may provide for a full 360° rotation to allow the operator to effectively move in position the apparatus. Similarly, depending on the application, one or more of the wheels/casters/rollers 5, 8 may be selectively lockable/releasable so that the apparatus remained in a desired location.

Some embodiments of the apparatus may be provided with stabilizing elements including, for example, the rear cross bar 4. Additional stabilizing elements may be provided on the apparatus frame, particularly for applications that may require lifting heavy or unbalanced loads. These stabilizers may be arranged and configured with arms that can swing out and/or down from the frame and contact the floor in order to provide additional support. The terminal ends of the stabilizers may include one or more adjustable feet connected to toothed slides or screws that will allow for fine adjustment of the positioning of one or more of the feet.

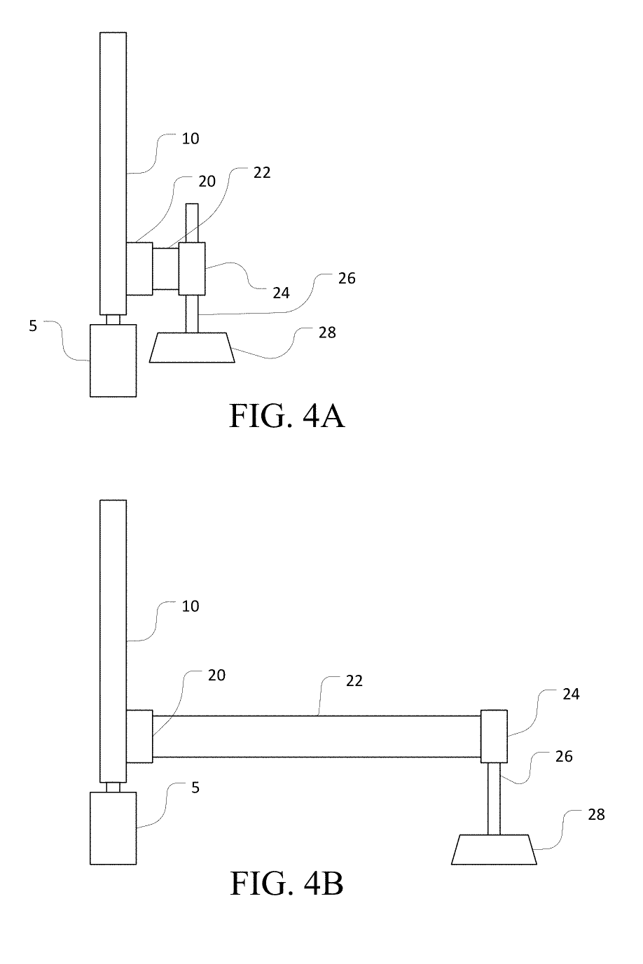

As illustrated in FIG. 4A, a vertical pivot joint 20 is provided on, for example the upper frame 10. A support arm 22 extends from the pivot joint and terminates in a fixture 24 that provides for adjustment of a support rod 26 on which is provided a foot 28. As illustrated in FIG. 4B, support arm may be pivoted from a position adjacent the upper frame to a use position in which the foot is extended away from the upper frame. The support rod 26 may then be adjusted as necessary to place the foot 28 on the floor and provide additional stability to the entire apparatus. As will be appreciated by those skilled in the art, the support mechanisms will typically be provided on both sides of the apparatus and may also be provided or attached to the lower frame 9.

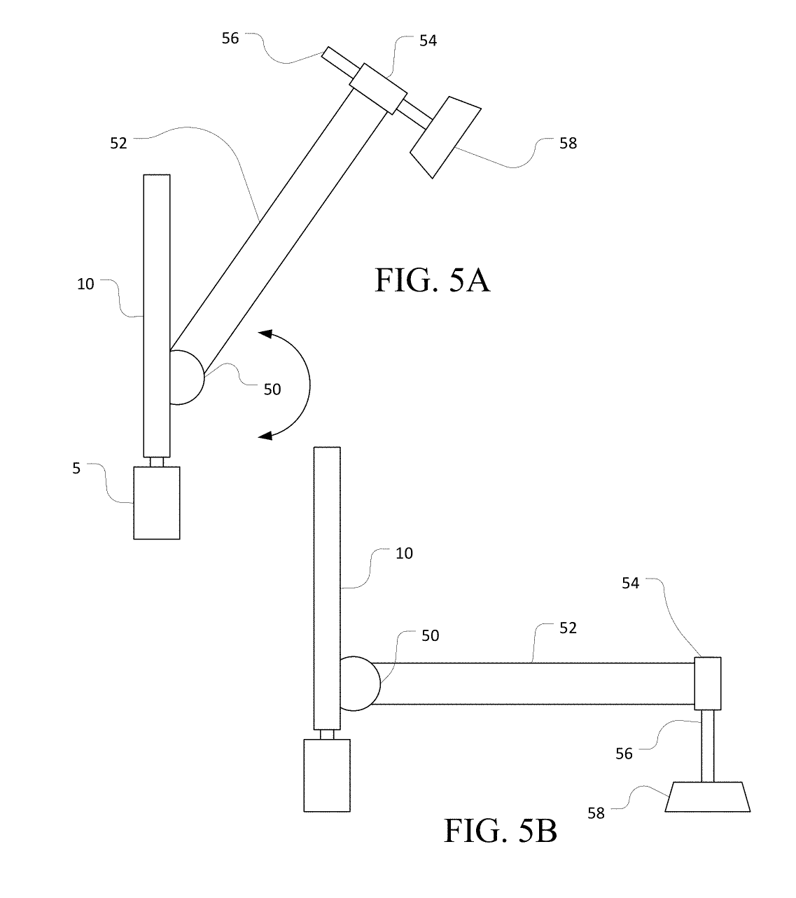

As illustrated in FIG. 5A, a horizontal pivot joint 50 is provided on, for example the upper frame 10. A support arm 52 extends from the pivot joint and terminates in a fixture 54 that provides for adjustment of a support rod 56 on which is provided a foot 58. As illustrated in FIG. 5B, support arm may be pivoted from a position adjacent the upper frame to a use position in which the foot is extended away from the upper frame. The support rod 56 may then be adjusted as necessary to place the foot 58 on the floor and provide additional stability to the entire apparatus. As will be appreciated by those skilled in the art, the support mechanisms will typically be provided on both sides of the apparatus and may also be provided or attached to the lower frame 9.

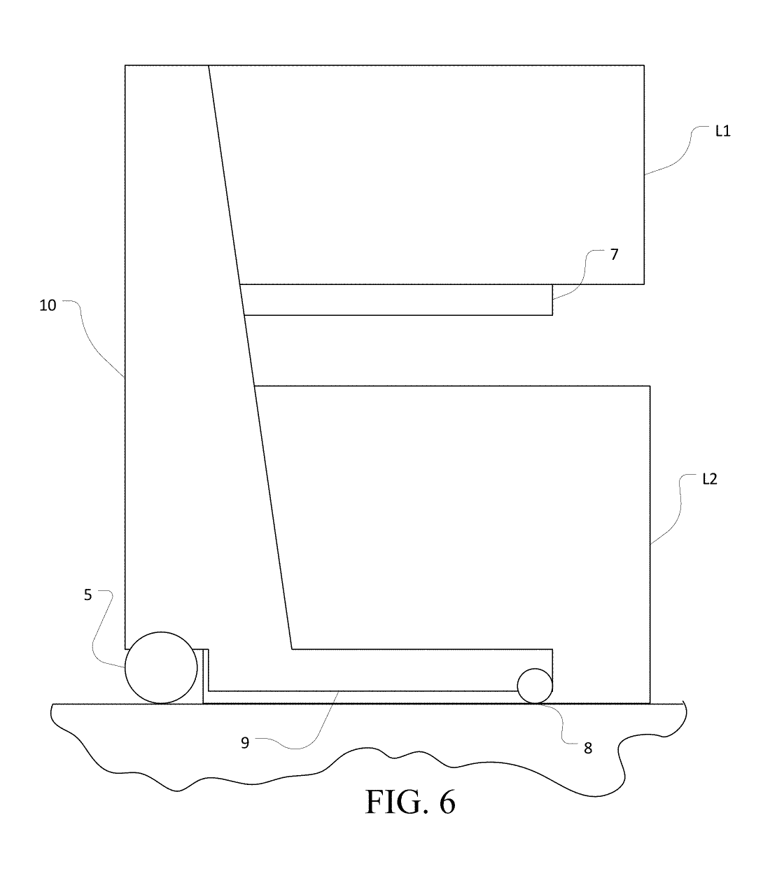

As illustrated in FIG. 6, in some embodiments of the apparatus, a single pair of lifting forks 7 is provided for lifting a first load L1 to an upper storage position thereby creating storage space below the first load in which a second load L2 can be deposited. Although as shown in FIG. 6, the second load is resting on the ground, the apparatus may be configured whereby a pallet jack or cart (not shown) carrying the second load L2 may be parked, thereby increasing the available storage without increasing the storage footprint.

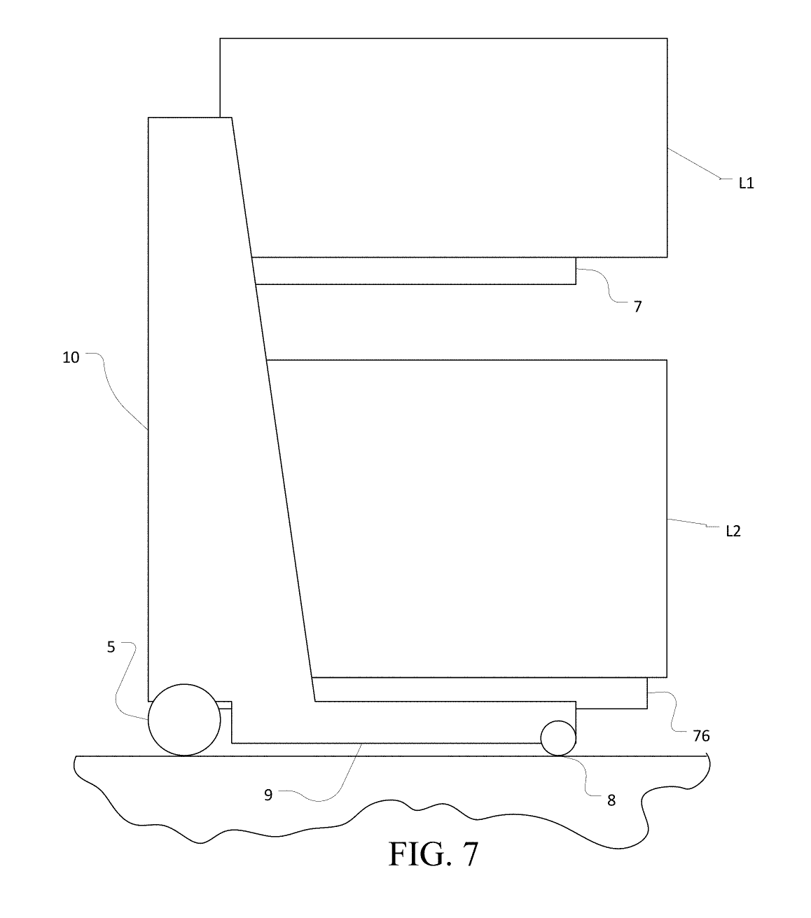

As illustrated in FIG. 7, in some embodiments of the apparatus, a single pair of lifting forks 7 is provided for lifting a first load L1 to an upper storage position thereby creating storage space below the first load in which a second load L2 can be deposited. The apparatus in FIG. 7, however, includes a secondary support structure 76 that can support the second load without the need for the use of a pallet jack or cart (not shown), thereby freeing up those tools for use with other loads and allowing both the first and second loads to be carried by the apparatus.

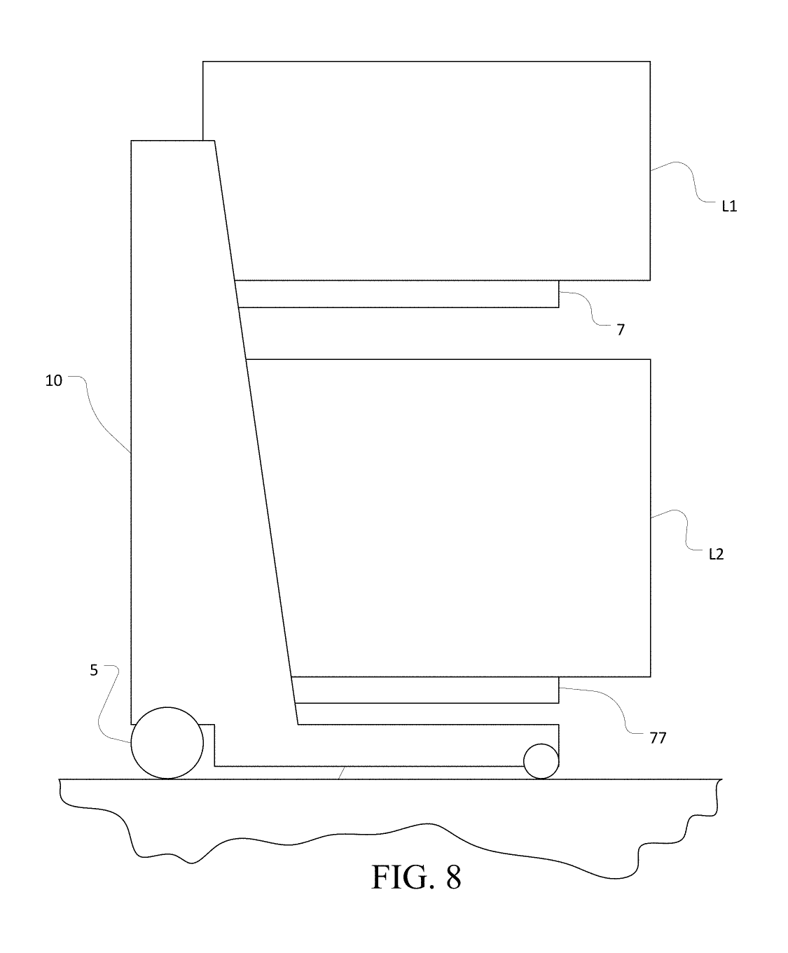

As illustrated in FIG. 8, in some embodiments of the apparatus, a first pair of lifting forks 7 is provided for lifting a first load L1 to an upper storage position thereby creating storage space below the first load in which a second load L2 can be deposited. The apparatus in FIG. 8, however, includes a second pair of lifting forks 77 that can be used to lift and support support the second load without the need for the use of a pallet jack or cart (not shown) to position the second load, thereby freeing up those tools for use with other loads and allowing both the first and second loads to be carried by the apparatus.

The foregoing disclosure is illustrative of the present invention and is not to be construed as limiting thereof. Although one or more embodiments of the invention have been described, persons of ordinary skill in the art will readily appreciate that numerous modifications could be made without departing from the scope and spirit of the disclosed invention. As such, it should be understood that all such modifications are intended to be included within the scope of this invention. The written description and drawings illustrate the present invention and are not to be construed as limited to the specific embodiments disclosed.

I claim:

1. An inventory control system comprising:
a pallet lift apparatus comprising
an upper frame;
a plurality of wheels supporting the upper frame
a moveable fork housing supported by the upper frame;
a plurality of lift forks extending from the fork housing configured for supporting a first pallet;
a lift mechanism supported by the upper frame and operatively connected to the fork housing for moving a first pallet supported by the fork housing between a lower position and an upper storage position;
a lower frame attached to and extending from the upper frame;
a plurality of rollers supporting the lower frame;
the pallet lift apparatus operable to receive and lift a first pallet; and
a pallet moving apparatus arranged and configured for supporting and moving a second pallet to a position below the first pallet.
